(19) United States
(12) Patent Application Publication
(10) Pub. No.: US 2023/0251722 A1
(43) Pub. Date: Aug. 10, 2023

(54) GESTURE SENSING SYSTEM AND SENSING METHOD THEREOF

(71) Applicant: Guangzhou Tyrafos Semiconductor Technologies Co., Ltd., Guangzhou (CN)

(72) Inventors: Kuan-Nan HU, Guangzhou (CN); Chung-Yen TSAI, Guangzhou (CN); Kai-Wen CHUANG, Guangzhou (CN)

(21) Appl. No.: 17/724,647

(22) Filed: Apr. 20, 2022

(30) Foreign Application Priority Data
Jan. 18, 2022 (TW) 111102087

(51) Int. Cl. G06F 3/01; G01S 17/42; G01S 17/58

(52) U.S. Cl. CPC G06F 3/017; G01S 17/42; G01S 17/58

(57) ABSTRACT

The present invention relates to a gesture sensing system that uses characteristic point as a positioning starting point to generate coordinate information in space for a test object. The gesture sensing system includes: a light emitter, a light sensor, and a signal processing module. The light emitter emits a plurality of emitted lights to the characteristic point and the test object, and the emitted light is reflected to generate a plurality of reflection light to be received and converted by the light sensor receives into a plurality of sensing signal. Then, the signal processing module generates initial coordinate information and movement coordinate information based on the sensing signals. Finally, the signal processing module generates a gesture according to the initial coordinate information and the change between the movement coordinate information, and executes a preset function according to the movement trajectory of the gesture.

### CROSS-REFERENCE TO RELATED APPLICATION

This application claims the priority of Taiwanese patent application No. 111102087, filed on Jan. 18, 2022, which is incorporated herewith by reference.

### BACKGROUND OF THE INVENTION

### 1. Field of the Invention

The present invention relates generally to a gesture sensing system, and more particularly, to a gesture sensing system utilizing optical properties and a sensing method thereof.

### 2. The Prior Arts

The known human-computer interaction methods have gradually moved toward a human-centered somatosensory detection method from the traditional use of a handheld controller as an input. At present, there are also somatosensory-based consumer electronic products on the market that allow users to achieve human-computer interaction control without holding a controller. There are three main ways to use them: gesture recognition methods based on two-dimensional images, and gesture recognition methods based on three-dimensional images, and the gesture recognition method based on electromagnetic induction.

However, the shortcoming of the gesture recognition method using the two-dimensional image is that the corresponding feature points are directly extracted from the image for recognition, which causes the gesture recognition method based on the two-dimensional image to be easily affected by factors such as the viewing angle and the light in the environment. Thus, the recognition success rate is low. The disadvantage of the gesture recognition method using 3D images is that multi-frame processing must be performed to calculate the depth. However, the longer exposure time may limit the overall screen update rate of the system. Also, due to the high processing rate and high processing complexity, the system must use an external application processor, resulting in more a plurality of algorithm and increased cost. In addition, the disadvantage of the gesture recognition method using electromagnetic induction is that the electromagnetic is easily interfered by metal objects, such as watches, accessories, and other metal objects, causing the risk of recognition errors.

China Patent No. CN110045819A discloses a gesture processing method and equipment, which relates to the field of electronic technology and can generate general input events to which both system applications and third-party applications can respond based on the gestures, so as to improve the use range of the gestures and eliminate the need for adaptation of third-party applications. The specific solution is: after the electronic device detects the gesture, it generates a general input event according to the gesture. The general input event is an input event that both system applications and third-party applications can respond to, and the electronic device responds to the general input event through related applications, thus responding to the gesture.

However, the shortcoming of the aforementioned gesture recognition methods is that, as they are based on infrared transducer for detecting gesture and analyzing the correspondence between the time and position coordinates of the gesture, they are easily interfered by various heat sources and sunlight sources, and the passive infrared penetration is poor, the infrared radiation of the human body is easily blocked, easily interfered by radio frequency radiation, and difficult to be received by the detector. At the same time, because the hand positioning must be performed actively, the algorithm is complicated and difficult to achieve the effect of real-time recognition.

Therefore, the inventors of the present invention devised the present invention after observing the aforementioned defects.

### SUMMARY OF THE INVENTION

A primary obj ective of the present invention is to provide a gesture sensing system, which uses a feature point as a positioning starting point to generate spatial coordinate information for the test object, thereby accurately determining whether the test object actually moves, which not only greatly reduces the complexity of the algorithm, but also improves the accuracy of the gesture sensing system. In addition, since the light emitter actively emits a plurality of emission light so as to cope with various ambient lighting conditions, even in the dark. The reflection light is only received through the light sensor, which can accurately generate the movement trajectory of the test object. The gesture sensing system according to the present invention has the advantages of low cost and wide applicability.

Another objective of the present invention is to provide a gesture sensing system, which stores a movement trajectory and a corresponding preset function in a storage unit, and executes the preset function according to the movement trajectory through a signal processing module. As such, the present invention allows users to define their own gestures, and at the same time to extend the corresponding activation functions, increase the flexibility of gesture use, and greatly increase the applicability and the recognition effect of the gesture sensing system.

In order to achieve the aforementioned objectives, the present invention provides a gesture sensing system, which uses a feature point as a positioning starting point to generate a plurality of spatial coordinate information for a test object. The gesture sensing system includes: a light emitter, for emitting a plurality of emission light to the feature point and the test object, and the emission light being reflected as a plurality of reflection light; a light sensor, electrically connected to the light emitter, for receiving the reflection light and converting into a plurality of sensing signals; and a signal processing module, coupled to the light emitter and the light sensor, for generating a positioning coordinate information of the feature point and an initial coordinate information of the test object according to the sensing signals, and generating a movement interval according to the initial coordinate information, and the movement interval being used for determining whether the test object moves; wherein, when the test object moves, the signal processing module generates a movement coordinate information, and when the movement coordinate information exceeds the movement interval, the signal processing module determines the test object produces a gesture.

Preferably, according to the gesture sensing system of the present invention, the gesture sensing system further includes: a storage unit, coupled to the signal processing module, for storing a movement trajectory of the gesture and a preset function corresponding to the movement trajectory; wherein, the signal processing module generates a path of the gesture according to the initial coordinate information and movement change between the movement coordinate information, compares the path of the gesture and the movement trajectory, and executes the preset function corresponding to the movement trajectory.

Preferably, according to the gesture sensing system of the present invention, the initial coordinate information includes a first coordinate value generated along a first direction and a second coordinate value generated along a second direction, and the movement coordinate information includes a first movement coordinate value generated along the first direction and a second movement coordinate value generated along the second direction.

Preferably, according to the gesture sensing system of the present invention, the first direction and the second direction are perpendicular to each other, and a plane formed by the first direction and the second direction is perpendicular to incident direction of the emitted light; however, the present invention is not limited thereto.

Preferably, according to the gesture sensing system of the present invention, the signal processing module divides the plane according to the positioning coordinate information, the first direction, and the second direction, with the positioning coordinate information as an origin, into four quadrants, and the signal processing module confirms the quadrant where the test object is located according to the positioning coordinate information and the movement coordinate information, but the present invention is not limited to thereto.

Preferably, according to the gesture sensing system of the present invention, the initial coordinate information further includes a third coordinate value generated along a third direction, and the movement coordinate information includes a third movement coordinate value along the third direction; however, the present invention is not limited to thereto.

Preferably, according to the gesture sensing system of the present invention, the first direction, the second direction and the third direction are perpendicular to one another, but the present invention is not limited thereto.

Preferably, according to the gesture sensing system of the present invention, the test object is the hand of a human body, and the feature point is any part of the human body other than the hand.

Preferably, according to the gesture sensing system of the present invention, the signal processing module is one of a server, a computer, and an integrated circuit.

Also, in order to achieve the aforementioned objectives, based on the aforementioned gesture sensing system, the present invention further provides a sensing method for executing the aforementioned gesture sensing system, which includes: a positioning emission step, the light emitter of the gesture sensing system emitting a positioning emission light to the feature point, and the positioning emission light being reflected by the feature point to generate a positioning reflection light; a positioning sensing step, the light sensor of the gesture sensing system receiving the positioning reflection light and converting into a positioning sensing signal; a positioning operation step, the signal processing module generating the positioning coordinate information of the feature point according to the positioning sensing signal; an initial emission step, the light emitter of the gesture sensing system emitting an initial emission light to the test object, and the initial emission light being reflected by the test object to generate an initial reflection light; an initial sensing step, the light sensor of the gesture sensing system receiving the initial reflection light and converting into an initial sensing signal; an initial operation step, the signal processing module generating the initial coordinate information of the test object according to the initial sensing signal, and generating a movement interval according to the initial coordinate information; a movement emission step, the light emitter of the gesture sensing system emitting a movement emission light to the test object, and the movement emission light is reflected by the test object to generate a movement reflection light; a movement sensing step, the light sensor of the gesture sensing system receiving the movement reflection light and converting into a movement sensing signal; a movement operation step, the signal processing model generating the movement coordinate information of the test object according to the movement sensing signal; and a determining step, when the movement coordinate information exceeding the movement interval, the signal processing module determining that the test object generating a gesture.

Preferably, the sensing method of the present invention further comprises: a comparison step, the signal processing module generating the path of the gesture according to the movement change between the initial coordinate information and the movement coordinate information, and the signal processing module comparing the gesture path with a movement trajectory.

Preferably, the sensing method of the present invention further comprises: a storage step, a storage unit storing the movement trajectory of the gesture, and the signal processing module receiving the preset function corresponding to the movement trajectory, and the storage unit storing the preset function.

Preferably, the sensing method of the present invention further comprises: an execution step, when the signal processing module determining the path of the gesture consistent with the movement trajectory, the signal processing module performing he preset function according to the movement trajectory.

Preferably, the sensing method of the present invention further comprises: a dividing step, the signal processing module, based on the positioning coordinate information, the first direction, and the second direction, dividing the space where the test object is located into four quadrants; and a confirmation step, the signal processing module confirming the quadrant where the test object being located according to the positioning coordinate information and the movement coordinate information.

The gesture sensing system and sensing method thereof provided by the present invention mainly use the gesture sensing system of the present invention, in combination with the sensing method, to use a feature point as a positioning starting point to generate a coordinate information to accurately determine whether the test object is movement, which not only greatly reduces the complexity of the algorithm, but also improves the accuracy of the gesture sensing system. In addition, since the light emitter actively emits a plurality of emission light, the present invention can cope with various ambient lighting conditions, even in the dark. The reflection light is only received through the light sensor, which can accurately generate the movement trajectory of the test object. The gesture sensing system according to the present invention has the advantages of low cost and wide applicability.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a gesture sensing system of the present invention;

FIG. 2 is a schematic view illustrating emission light and reflection light of the gesture sensing system of the present invention;

FIG. 3 is a flowchart illustrating the steps of implementing the sensing method of the gesture sensing system of the present invention;

FIG. 4 is a schematic view illustrating the steps of implementing the sensing method of the gesture sensing system of the present invention;

FIG. 5 is a schematic view of a gesture sensing system according to a first embodiment of the present invention;

FIG. 6 is a schematic view illustrating the use of the gesture sensing system according to the first embodiment of the present invention;

FIG. 7 is a flowchart illustrating the steps of the sensing method according to the first embodiment of the present invention;

FIG. 8 is a schematic view illustrating the steps of the actual execution process of the recognition method according to the first embodiment of the present invention;

FIG. 9 is a schematic view illustrating the use of the gesture sensing system according to the second embodiment of the present invention; and

FIG. 10 is a flowchart illustrating the steps of implementing the sensing method of the gesture sensing system according to the second embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

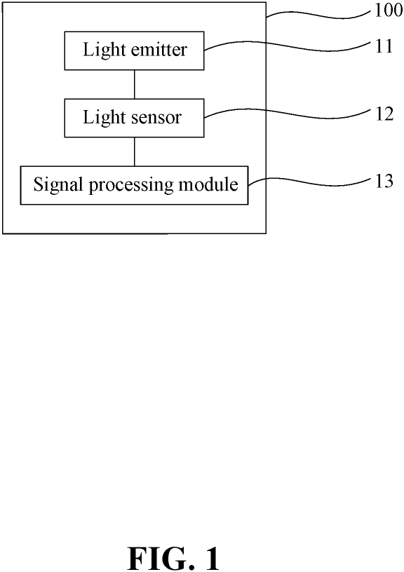

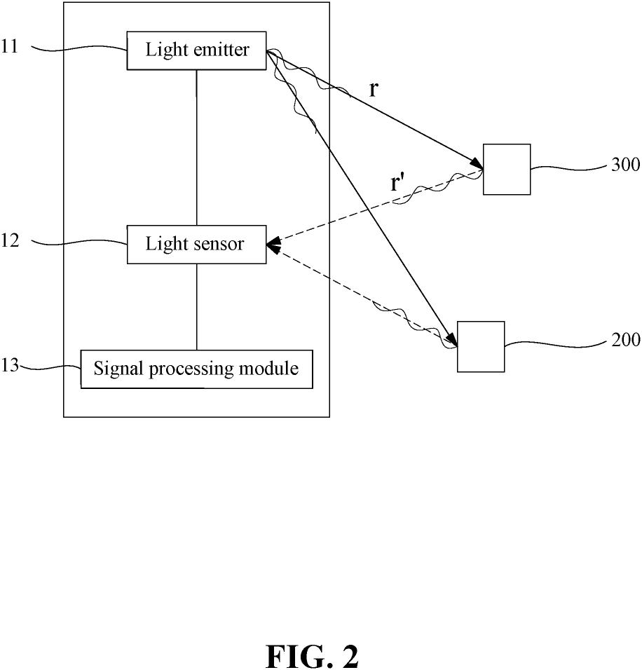

Please refer to FIG. 1 and FIG. 2. FIG. 1 is a schematic view of a gesture sensing system of the present invention; FIG. 2 is a schematic view illustrating emission light and reflection light of the gesture sensing system of the present invention. As shown in FIG. 1, the gesture sensing system 100 according to the present invention includes: a light emitter 11, a light sensor 12, and a signal processing module 13.

Specifically, as shown in FIG. 2, the light emitter 11 of the present invention emits a plurality of emission light r to the feature point 200 and the test object 300, and the emission light r is reflected by the feature point 200 and the test object 300 to generate a plurality of reflection light r′. It should be further noted that the light emitter 11 can use a laser beam or an LED beam as the emission light r, so that the wavelength of the emission light r emitted by the light emitter 20 is between 360 nm and 1550 nm, such as, 495 nm, 650 nm, 850 nm, 940 nm, 1300 nm, 1310 nm, 1350 nm, and so on, but the present invention is not limited thereto.

Furthermore, because the wavelength of the laser used for recognition in general smart phones is 940 nm, and the infrared laser of this wavelength has also been medically proven to be harmful to the human eye, causing cataracts and retinal burns; on the other hand, the laser beams that can be used in the present invention have a wavelength of 1310 nm, and more specifically, are harmless to the eyes of users.

It is worth noting that, in the present embodiment, the emission light r emitted by the light emitter 11 can have pulses of high-energy light, which can cope with ambient lighting conditions, and therefore is suitable for working in various outdoor applications, and at the same time can be used in long-distance applications to effectively reduce the overall power consumption of the system, but the present invention is not limited to thereto.

Specifically, as shown in FIG. 2, the light sensor 12 according to the present invention is electrically connected to the light emitter 11, and the light sensor 12 receives the reflection light r′ and converts into a plurality of sensing signals, however the present invention is not limited thereto.

It should be further noted that the feature point 200 in the present invention can be any object in the three-dimensional space. Specifically, in some embodiments, the feature point 200 is any part of the human body other than the hand. The user can select different feature points 200 according to the location and the relative position to the gesture sensing system 100. For example, in some embodiments, when a user uses the gesture sensing system 100 of the present invention in a car, the feature points 200 may be the user’s nose, mouth, jaw and other facial features, and with the feature points 200 as a positioning starting point, a plurality of spatial coordinate information is generated for the test object 300. It is worth noting that the reason for choosing the user’s nose, mouth, jaw and other facial features as the starting point for positioning is that the human body is generally used to raising the hand near the face when gesturing, so the facial features are used as the starting point for positioning in order to avoid the risk of inaccurate sensing caused by the distance between the feature point 200 and the test object 300 being too large. Specifically, the feature point 200 can also be the intersection point of the chest line and the waist, or, the feature point 200 can also be an accessory, such as a pendant, a metal sheet, etc., worn by the user. Depending on the limitations of the current environment and usage based on the user’s intention, the user can select appropriate feature points 200 according to their own needs, and the feature points 200 described in the present invention should not be interpreted as being limited to facial features.

It is worth noting that, in some embodiments, the test object 300 according to the present invention can be a human hand, and the gesture sensing system 100 can actively detect the position of the feature point 200 and the test object 300. The coordinate information of the test object 300 relative to the feature point 200 is tracked and recorded, so that manual positioning is not required, and effects such as reducing the complexity of the calculation and the recognition time of the gesture sensing system 100 are realized.

Specifically, as shown in FIG. 1, the signal processing module 13 of the present invention is coupled to the light emitter 11 and the light sensor 12, and the signal processing module 13, based on the sensing signals, generates a positioning coordinate information of the feature point 200 and an initial coordinate information of the test object 300, and a movement interval is generated according to the initial coordinate information. The movement interval is used to determine whether the test object 300 moves. It should be further noted that, in some embodiments, the movement interval according to the present invention can be manually set. When the range of the movement interval is larger, the possibility of misjudgment by the gesture sensing system 100 of the present invention can be reduced but the sensitivity of the gesture sensing system 100 is also reduced. On the other hand, when the range of the movement interval is smaller, the sensitivity of the gesture sensing system 100 is improved, but the risk of misjudgment by the gesture sensing system 100 is increased. The user can select a movement interval with a more appropriate range, so that the applicability and recognition capability of the gesture sensing system 100 of the present invention are both achieved.

It is worth noting that the movement interval of the present invention can be a numerical value. For example, when the initial coordinate information is 2-dimensional coordinate information, the initial coordinate information can include an x-coordinate value and a y-coordinate value. When the test object 300 moves, the x-coordinate value and y-coordinate value of the coordinate information of the test object 300 after the movement is subtracted from the x-coordinate value and y-coordinate value of the initial coordinate information. If one of the x-coordinate value and the y-coordinate value after the subtraction is greater than the movement interval, the gesture sensing system 100 determines that the test object 300 generates a gesture; on the other hand, if the subtracted values of the x-coordinate value and the y-coordinate value are both smaller than the movement interval, the gesture sensing system 100 determines that the test object 300 does not generate a gesture, but the present invention is not limited thereto.

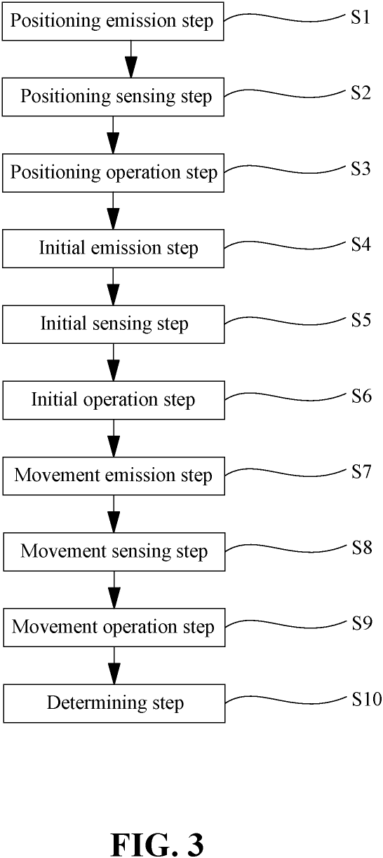

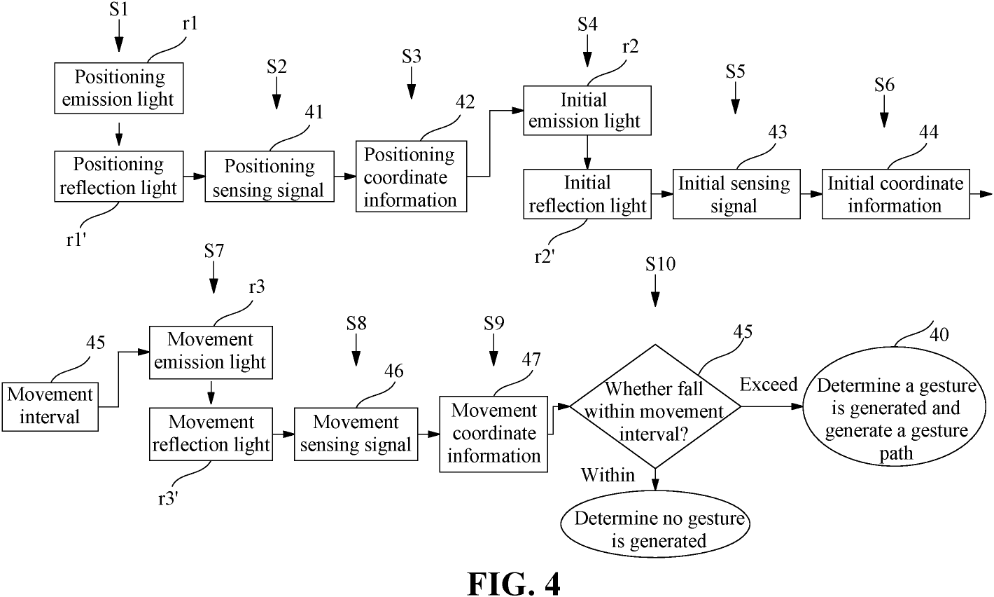

Refer to FIG. 3 and FIG. 4, in conjunction with FIG. 1 and FIG. 2. FIG. 3 is a flowchart illustrating the steps of implementing the sensing method of the gesture sensing system of the present invention; FIG. 4 is a schematic view illustrating the steps of implementing the sensing method of the gesture sensing system of the present invention. Based on the gesture sensing system 100, the present invention further provides a sensing method of the gesture sensing system 100, which includes the following steps:

Positioning emission step S1: the light emitter 11 of the gesture sensing system 100 emits the positioning emission light r1 to the feature point 200. The positioning emission light r1 is emitted to and reflected by the feature point 200 to generate the positioning reflection light r1′, and then the positioning sensing step S2 is performed.

Positioning sensing step S2: the light sensor 12 of the gesture sensing system 100 receives the positioning reflection light r1′, and converts into the positioning sensing signal 41, and then executes the positioning operation step S3.

Positioning operation step S3: the signal processing module 13 generates the positioning coordinate information 42 of the feature point 200 according to the positioning sensing signal 41, and then performs the initial transmission step S4.

Initial emission step S4: the light emitter 11 of the gesture sensing system 100 emits an initial emission light r2 to the test object 300, and the initial emission light r2 is emitted to and reflected by the test object 300 to generate the initial reflection light r2′ and then the positioning initial sensing step S5 is performed.

Initial sensing step S5: the light sensor 12 of the gesture sensing system 100 receives the initial reflection light r2′ and converts into the initial sensing signal 43, and then performs the positioning initial operation step S6.

Initial operation step S6: the signal processing module 13 generates the initial coordinate information 44 of the test object 300 according to the initial sensing signal 43, and generates the movement interval 45 according to the initial coordinate information 44, and then executes the movement emission step S7.

Movement emission step S7: the light emitter 11 of the gesture sensing system 100 emits a movement emission light r3 from the test object 300, and after the movement emission light r3 is emitted to and reflected by the test object 300 to generate the movement reflection light r3′, the movement sensing step S8 is performed.

Movement sensing step S8: the light sensor 12 of the gesture sensing system 100 receives the movement reflection light r3′, and converts into a movement sensing signal 46, and then executes the movement operation step S9.

Movement operation step S9: the signal processing module 13 generates the movement coordinate information 47 of the test object 300 according to the movement sensing signal 46, and then executes the determining step S10.

Determining step S10: when the movement coordinate information 47 falls into the movement interval 45, the signal processing module 13 determines that the test object 300 does not generate a gesture; otherwise, the signal processing module 13 determines that the test object 300 generates the gesture 40.

As such, it can be known from the above description that, according to the gesture sensing system 100 provided by the present invention and the sensing method thereof, the feature point 200 is used as the positioning starting point to generate the spatial positioning coordinate information 42 for the test object 300, and a movement interval 45 is generated according to the initial coordinate information 44, thereby accurately determining whether the test object 300 generates a gesture based on the movement interval 45, so that it is not necessary to actively locate the human hand, nor to the fingertip, which greatly reduces the complexity of the algorithm, and the accuracy of the gesture sensing system 100 is also improved with the range of the movement interval 45. In addition, since the light emitter 11 actively emits a plurality of emission light r, it can cope with various ambient lighting conditions, even in the dark, and only the light sensor 12 receives the reflection light r′ so as to accurately generate the movement coordinate information 47 of the test object; that is, the gesture sensing system 100 according to the present invention has the effects of low cost and wide applicability.

In order to further understand the structural features of the present invention, the application of technical means and the expected effect, the actual execution process of the present invention will be described as follows.

Refer to FIG. 4, in conjunction with FIG. 1 and FIG. 2. The actual execution process of the gesture sensing system 100 according to the present invention is described as follows: firstly, the positioning emission step S1 is performed, and the positioning emission light r1 is emitted toward the feature point 200 by the light emitter 11, and reflected by the feature point 200 to generate the positioning reflection light r1′; then, the positioning sensing step S2 is performed. After the light sensor 12 of the gesture sensing system 100 receives the positioning reflection light r1′ and converts the positioning reflection light r1′ into the positioning sensing signal 41 according to the positioning emission light r1 and the positioning reflection light r1′; then the positioning operation S3 is performed, wherein the signal processing module 13 generates the positioning coordinate information 42 of the feature point 200 according to the positioning sensing signal 41 to be used as the origin of the coordinate information of the test object 300; followed by performing the initial emission step S4 to use the light emitter 11 to emit the initial emission light r2 to the test object 300, and the test object 300 reflects the initial emission light r2 to generate the initial reflection light r2′; then the initial sensing step S5 is performed, and the light sensor 12 of the gesture sensing system 100 receives the initial reflection light r2′. According to the initial emission light r2 and the initial reflection light r2′, the light sensor 12 converts the light into the initial sensing signal 43; after that, the initial operation step S6 is performed, wherein the signal processing module 13 generates the initial coordinate information 44 of the test object 300 according to the initial sensing signal 43 to be used as the starting point of the coordinate information of the test object 300, and the movement interval 45 is generated according to the initial coordinate information 44; then the movement emission step S7 is performed, wherein the movement emission light r3 is emitted by the light emitter 11 to and reflected by the test object 300 to generate the movement reflection light r3′; then the movement sensing step S8 is performed, wherein the light sensor 12 of the gesture sensing system 100 receives the movement reflection light r3′, and converts into the movement sensing signal 46 according to the movement emission light r3 and movement reflection light r3′; then the movement operation step S9 is performed, in which the signal processing module 13 generates the movement coordinate information 47 of the test object 300 according to the movement sensing signal 46, as the end point after the object 300 moves; and finally, the determining step S10 is performed, wherein when the movement coordinate information 47 falls into the movement interval 45, the signal processing module 13 determines that the test object 300 does not generate a gesture; otherwise, the signal processing module 13 determines that the test object 300 generates a gesture 40.

Hereinafter, the first embodiment of the gesture sensing system 100 of the present invention will be described with reference to the drawings, so that those skilled in the art of the present invention may more clearly understand possible changes. Elements denoted by the same reference numerals as above are substantially the same as those described above with reference to FIGS. 1 and 2. The same elements, features, and advantages as gesture sensing system 100 will not be repeated.

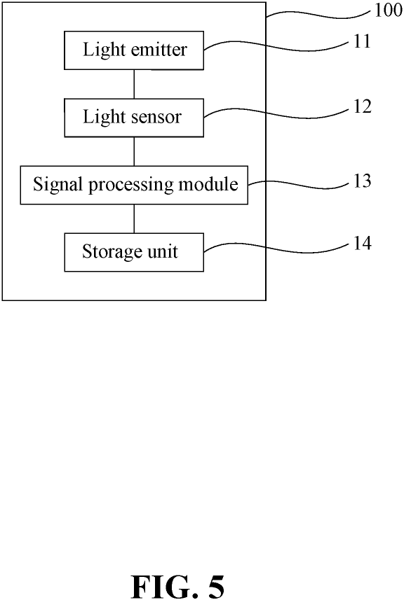

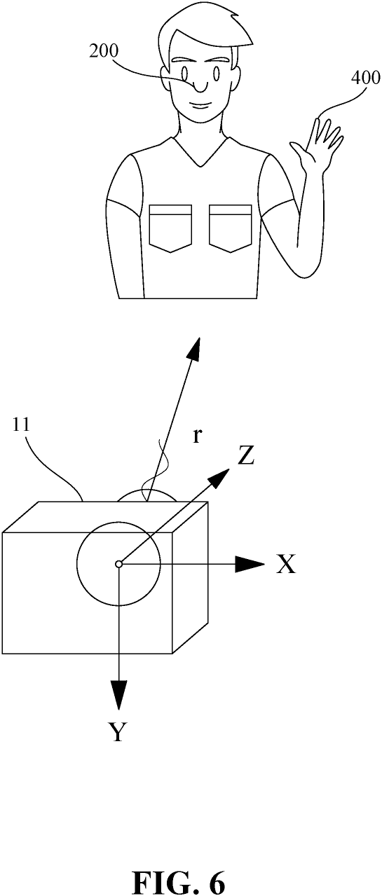

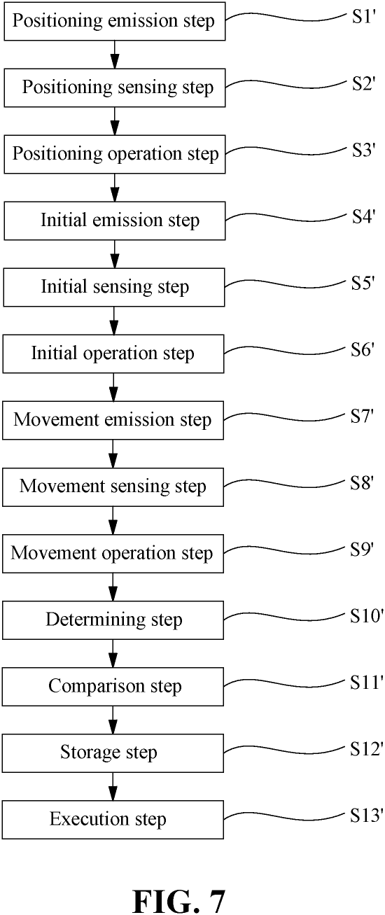

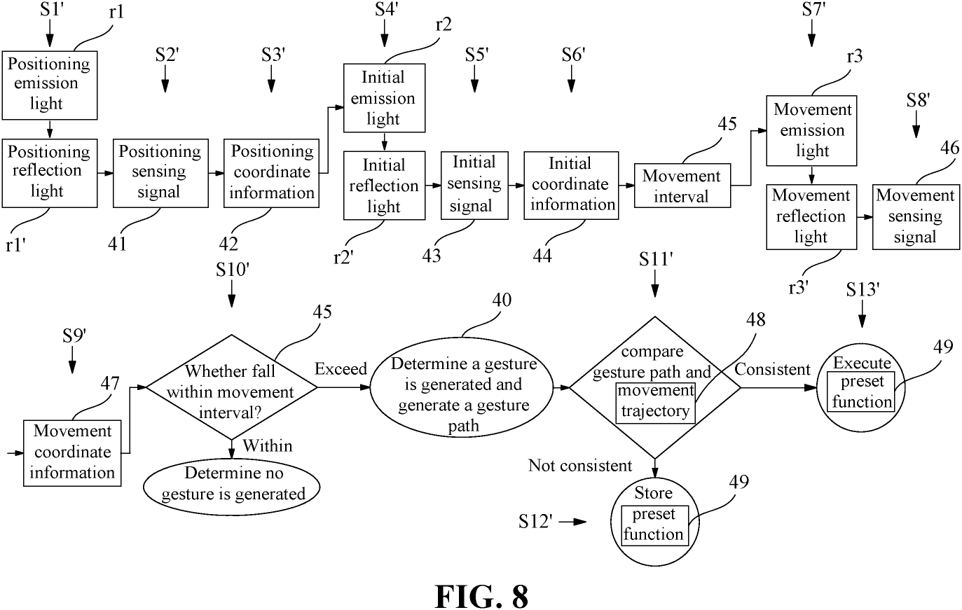

Refer to FIGS. 5-8. FIG. 5 is a schematic view of a gesture sensing system according to a first embodiment of the present invention; FIG. 6 is a schematic view illustrating the use of the gesture sensing system according to the first embodiment of the present invention; FIG. 7 is a flowchart illustrating the steps of the sensing method according to the first embodiment of the present invention; FIG. 8 is a schematic view illustrating the steps of the actual execution process of the recognition method according to the first embodiment of the present invention. As shown in FIG. 5, the gesture sensing system 100 according to the present invention includes: a light emitter 11, a light sensor 12, a signal processing module 13, and a storage unit 14.

Specifically, as shown in FIGS. 5-8, the gesture sensing system 100 according to the first embodiment of the present invention further includes a storage unit 14, and the storage unit 14 is coupled to the signal processing module 13. It is worth noting that, in the present embodiment, after the signal processing module 13 determines that the test object 300 generates a gesture, the signal processing module 13 can generate a gesture path 40 of the test object 300 according to the initial coordinate information 44 and the movement coordinate information 47 generated in real time. In addition, the user can store a movement trajectory 48 and a preset function 49 corresponding to the movement trajectory 48 in the storage unit 14, and execute the preset function 49 when the gesture path 40 is consistent with the movement trajectory 48. Thereby, the preset function 49 associated with hand movement can be customized according to one’s own needs, and a personal gesture can be established. In the meantime, the corresponding function can be activated, which greatly increases the flexibility of using the gesture of the present invention.

For example, the preset function 49 may be a control command for controlling volume, enabling navigation, controlling screen brightness, etc., for an external device connected to the gesture sensing system 100, or the preset function 49 may also be standby or shutdown commands for the gesture sensing system 100, which are directed to the control instructions of the gesture sensing system 100 itself, but the present invention is not limited thereto.

Specifically, refer to FIG. 6. In the present embodiment, the coordinate information 40 may include a first coordinate value X1 (not shown) generated along a first direction X, a second coordinate value Y1 (not shown) generated along a second direction Y, and a third coordinate value Z1 (not shown) generated along a third direction Z, wherein the first direction X, the second direction Y, and the third direction Z are perpendicular to one another. Thereby, the gesture sensing system 100 of the present invention can sense the movement of the test object 300 in the three-dimensional space, that is, the gesture sensing system 100 of the present invention can simultaneously sense the movement of height, width and depth, so that the present invention has broad applicability, but the present invention is not limited thereto.

Referring to FIG. 7 and FIG. 8, in conjunction with FIG. 5 and FIG. 6, the present invention is based on the gesture sensing system 100 of the first embodiment, and further provides a sensing method of the gesture sensing system 100, comprising the following steps:

In the positioning emission step S1′, the light emitter 11 of the gesture sensing system 100 emits the positioning emission light r1 to and reflected by the feature point 200 to generate the positioning reflection light r1′; then, the positioning sensing step S2′ is performed.

In the positioning sensing step S2′, the light sensor 12 of the gesture sensing system 100 receives the positioning reflection light r1′ and converts into a positioning sensing signal 41, and then executes the positioning operation step S3′.

In the positioning operation step S3′, the signal processing module 13 generates the positioning coordinate information 42 of the feature point 200 according to the positioning sensing signal 41, and then performs the initial emission step S4′.

In the initial emission step S4′, the light emitter 11 of the gesture sensing system 100 emits an initial emission light r2 to and reflected by the test object 300 to generate the initial reflection light r2′; then, the initial sensing step S5′ is performed.

In the initial sensing step S5′, the light sensor 12 of the gesture sensing system 100 receives the initial reflection light r2′ and converts into an initial sensing signal 43, and then performs the initial operation step S6′.

In the initial operation step S6′, the signal processing module 13 generates the initial coordinate information 44 of the test object 300 according to the initial sensing signal 43, and generates the movement interval 45 according to the initial coordinate information 44, and then executes the movement emission step S7′.

In the movement emission step S7′, the light emitter 11 of the gesture sensing system 100 emits a movement emission light r3 to and reflected by the test object 300 to generate a movement reflection light r3′, and then execute the movement sensing step S8′.

In the movement sensing step S8′, the light sensor 12 of the gesture sensing system 100 receives the movement reflection light r3′ and converts into a movement sensing signal 46, and then executes the movement operation step S9′.

In the movement operation step S9′, the signal processing module 13 generates the movement coordinate information 47 of the test object 300 according to the movement sensing signal 46, and then executes the determining step S10′.

In the determining step S10′, when the movement coordinate information 47 falls within the movement interval 45, the signal processing module 13 determines that the test object 300 does not generate a gesture; otherwise, the signal processing module 13 determines that the test object 300 generates a gesture 40, and then perform a comparison step S11′.

In the comparison step S11′, the signal processing module 13 generates the gesture path 40 according to the movement change between the initial coordinate information 44 and the movement coordinate information 47, and the signal processing module 13 compares the gesture path 40 with a movement trajectory 48, if both are not consistent with each other, a storage step S12′ is performed, otherwise, an execution step S13′ is performed.

In the storage step S12′, the storage unit 14 stores the movement trajectory 48, and the signal processing module 13 receives the preset function 49 corresponding to the movement trajectory 48, and the storage unit 14 stores the preset function 49.

In the execution step S13′, if the signal processing module 13 compares the gesture path 40 with the movement trajectory 48 and determines both are consistent with each other, the signal processing module 13 executes the preset function 49 corresponding to the movement trajectory 4.

In order to further understand the structural features of the present invention, the application of technical means and the expected effect, the actual execution process of the present invention will be described.

Refer to FIG. 8, in conjunction with FIG. 5 and FIG. 6. The actual execution process of the gesture sensing system 100 according to the present invention is described as follows: firstly, the positioning emission step S1′ is performed, and the positioning emission light r1 is emitted toward the feature point 200 by the light emitter 11, and reflected by the feature point 200 to generate the positioning reflection light r1′; then, the positioning sensing step S2′ is performed. After the light sensor 12 of the gesture sensing system 100 receives the positioning reflection light r1′ and converts the positioning reflection light r1′ into the positioning sensing signal 41 according to the positioning emission light r1 and the positioning reflection light rl′; then the positioning operation S3′ is performed, wherein the signal processing module 13 generates the positioning coordinate information 42 of the feature point 200 according to the positioning sensing signal 41 to be used as the origin of the coordinate information of the test object 300; followed by performing the initial emission step S4′ to use the light emitter 11 to emit the initial emission light r2 to the test object 300, and the test object 300 reflects the initial emission light r2 to generate the initial reflection light r2′; then the initial sensing step S5′ is performed, and the light sensor 12 of the gesture sensing system 100 receives the initial reflection light r2′. According to the initial emission light r2 and the initial reflection light r2′, the light sensor 12 converts the light into the initial sensing signal 43; after that, the initial operation step S6′ is performed, wherein the signal processing module 13 generates the initial coordinate information 44 of the test object 300 according to the initial sensing signal 43 to be used as the starting point of the coordinate information of the test object 300, and the movement interval 45 is generated according to the initial coordinate information 44; then the movement emission step S7′ is performed, wherein the movement emission light r3 is emitted by the light emitter 11 to and reflected by the test object 300 to generate the movement reflection light r3′; then the movement sensing step S8′ is performed, wherein the light sensor 12 of the gesture sensing system 100 receives the movement reflection light r3′, and converts into the movement sensing signal 46 according to the movement emission light r3 and movement reflection light r3′; then the movement operation step S9′ is performed, in which the signal processing module 13 generates the movement coordinate information 47 of the test object 300 according to the movement sensing signal 46, as the end point after the object 300 moves; and finally, the determining step S10′ is performed, wherein when the movement coordinate information 47 falls into the movement interval 45, the signal processing module 13 determines that the test object 300 does not generate a gesture; otherwise, the signal processing module 13 determines that the test object 300 generates a gesture 40. If the signal processing module 13 determines that the test object 300 produces the gesture 40, the comparison step S11′ is performed, wherein the signal processing module 13 generates a gesture path 40 according to the movement change between the initial coordinate information 44 and the movement coordinate information 47, and the gesture path 40 is compared with the movement trajectory 48; if the storage unit 14 does not store the movement trajectory 48 consistent with the gesture path 40, the storage step S12′ is executed, and the storage unit 14 stores the movement trajectory 48 corresponding to the gesture path 40, and the signal processing module 13 receives the preset function 49 corresponding to the movement trajectory 48, and the storage unit 14 stores the preset function 49; when the movement trajectory 48 is consistent with the gesture path 40 in step S11′, step S13′ is executed, and the signal processing module 13 performs the preset function 49 corresponding to the movement trajectory 48.

Thereby, the gesture sensing system 100 of the present invention further stores the movement trajectory 48 and the corresponding preset function 49 in the storage unit 14, and executes the preset function 49 corresponding to the movement trajectory 48 by the signal processing module 13. As such, the present invention realizes a way for users to define their own gestures, for users to create personal gestures for activating the corresponding function, increasing the flexibility of gesture use, and greatly increasing the applicability and the recognition capability of the gesture sensing system 100.

Other embodiments of the gesture sensing system 100 are provided below to make possible variations more clearly understood by those skilled in the art to which the present invention pertains. Elements denoted by the same reference numerals as the above-mentioned embodiments are substantially the same as those described above with reference to FIG. 1 and FIG. 5. The same elements, features, and advantages as the recognition system 100 will not be repeated.

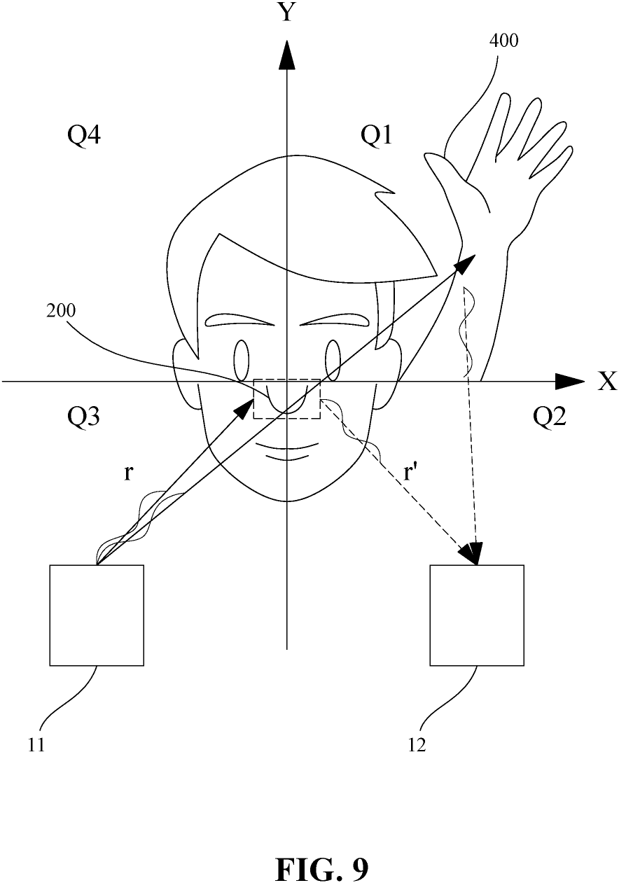

Refer to FIG. 9. FIG. 9 is a schematic view illustrating the use of the gesture sensing system according to the second embodiment of the present invention. The main difference between the second embodiment and the first embodiment is that, in the present embodiment, the coordinate information only includes the first coordinate value X1 generated along the first direction X and the second coordinate value generated along the second direction Y value Y1, and the signal processing module uses the positioning coordinate information 42 as the origin, and uses the plane formed by the first direction X and the second direction Y, the plane is perpendicular to the incident direction of the emission light. The space where the test object 300 is in is divided into four quadrants, namely the first quadrant Q1, the second quadrant Q2, the third quadrant Q3, and the fourth quadrant Q4, and through the change of the test object 300 between the quadrants, the present invention determines whether the test object 300 moves, and the sequence of the movement of the test object 300 in the four quadrants is tracked and recorded at the same time, so as to execute the corresponding preset function 49. Therefore, the gesture sensing system 100 according to the second embodiment of the present invention can provide a simplified algorithm as implementation compared with the first embodiment, and can determine whether the test object 300 generating a gesture only through the change between the quadrants, the user can choose which method is more appropriate according to the user’s needs, and the present invention should not be construed as being limited to thereto.

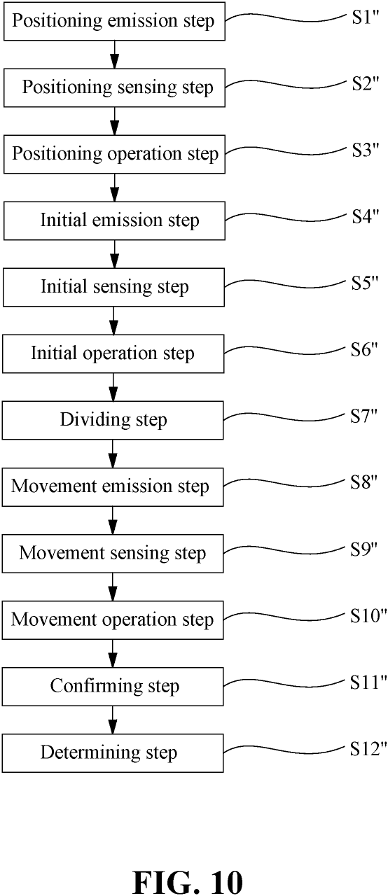

Refer to FIG. 10 in conjunction with FIG. 9. FIG. 10 is a flowchart illustrating the steps of implementing the sensing method of the gesture sensing system according to the second embodiment of the present invention. Based on the gesture sensing system 100 of the second embodiment, the present invention further provides a sensing method of the gesture sensing system 100 of the second embodiment, which includes the following steps:

In the positioning emission step S1″, the light emitter 11 of the gesture sensing system 100 emits the positioning emission light r1 to and reflected by the feature point 200 to generate the positioning reflection light r1′; then, the positioning sensing step S2″ is performed.

In the positioning sensing step S2″, the light sensor 12 of the gesture sensing system 100 receives the positioning reflection light r1′ and converts into a positioning sensing signal 41, and then executes the positioning operation step S3″.

In the positioning operation step S3″, the signal processing module 13 generates the positioning coordinate information 42 of the feature point 200 according to the positioning sensing signal 41, and then performs the initial emission step S4″.

In the initial emission step S4″, the light emitter 11 of the gesture sensing system 100 emits an initial emission light r2 to and reflected by the test object 300 to generate the initial reflection light r2′; then, the initial sensing step S5″ is performed.

In the initial sensing step S5″, the light sensor 12 of the gesture sensing system 100 receives the initial reflection light r2′ and converts into an initial sensing signal 43, and then performs the initial operation step S6″.

In the initial operation step S6″, the signal processing module 13 generates the initial coordinate information 44 of the test object 300 according to the initial sensing signal 43, and generates the initial coordinate information 44, and then executes the dividing step S7″.

In the dividing step S7″, the signal processing module 13 divides the space where the test object 300 is located into four quadrants according to the initial coordinate information 44, the first direction X, and the second direction Y, and then executes movement emission Step S8″.

In the movement emission step S8″: the light emitter 11 of the gesture sensing system 100 emits a movement emission light r3 from the test object 300, and after the movement emission light r3 is emitted to and reflected by the test object 300 to generate the movement reflection light r3′, the movement sensing step S9″ is performed.

In the movement sensing step S9″: the light sensor 12 of the gesture sensing system 100 receives the movement reflection light r3′, and converts into a movement sensing signal 46, and then executes the movement operation step S10″.

In the movement operation step S10″: the signal processing module 13 generates the movement coordinate information 47 of the test object 300 according to the movement sensing signal 46, and then executes the confirming step S11″.

In the confirming step S11″, the signal processing module 13 determines the quadrant where the object 300 is located according to the positioning coordinate information 44 and the movement coordinate information 47, and then executes the determining step S12″.

In the determining step S12″, when the quadrant of the positioning coordinate information 44 of the test object 300 and the quadrant of the movement coordinate information 47 are consistent, the signal processing module 13 determines that the test object 300 does not generate a gesture 40; otherwise, the signal processing module 13 determines that the object 300 generates the gesture 40.

Therefore, it can be known from the above description that the gesture sensing system 100 according to the second embodiment of the present invention and the sensing method thereof use the feature point 200 as the origin of positioning and uses the first direction X and the second directions Y to divide the space where the test object 300 is located into four quadrants, and the signal processing module 13 determines the quadrant where the test object 300 is located according to the positioning coordinate information 44 and the movement coordinate information 47 information; thereby, whether the test object 300 actually moves is accurately determined by whether the quadrants in which it is located are consistent, further reducing the complexity of the algorithm.

Hereby, the features of the present invention and the expected effects that can be achieved are stated as follows:

First, the present invention uses the feature point 200 as the positioning starting point to generate the spatial positioning coordinate information 44 for the test object 300, and generates the movement interval 45 according to the initial coordinate information 44, thereby, accurately determining whether the test object 300 actually moves based on the movement interval 45, so that it is not necessary to actively position the human hand, and not necessary to position the fingertip, which greatly reduces the complexity of the algorithm, and also improves the accuracy of the gesture sensing system 100 through the range of the movement interval 45.

Second, the present invention uses the light emitter 11 to actively emit a plurality of emission light r, so as to cope with various ambient lighting conditions, even in the dark. The reflection light r′ is only received through the light sensor 12, which can accurately generate the movement coordinate information 47 of the test object. The gesture sensing system 100 according to the present invention has the advantages of low cost and wide applicability.

Third, the present invention stores the movement trajectory 48 and the corresponding preset function 49 in the storage unit 14, and executes the preset function 49 corresponding to the movement trajectory 48 through the signal processing module 13, so as to realize a way of allowing users to define their own gestures, and able to activate the corresponding activation functions, which increases the flexibility of using gestures, and greatly increases the applicability and recognition capability of the gesture sensing system 100 .

Fourth, the present invention uses the feature point 200 as the positioning starting point and uses the first direction X and the second direction Y to divide the space where the test object 300 is located into four quadrants, and the signal processing module 13, according to the positioning coordinate information 44 and the movement coordinate information 47, determines whether the test object 300 actually moves by determining whether the quadrant of the test object 300 the quadrants are consistent, which further reduces the complexity of the algorithm.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A gesture sensing system, using a feature point as a positioning starting point to generate a plurality of spatial coordinate information for a test object, the gesture sensing system comprising:
a light emitter, for emitting a plurality of emission light to the feature point and the test object, and the emission light being reflected as a plurality of reflection light;
a light sensor, electrically connected to the light emitter, for receiving the reflection light and converting into a plurality of sensing signals; and
a signal processing module, coupled to the light emitter and the light sensor, for generating a positioning coordinate information of the feature point and an initial coordinate information of the test object according to the sensing signals, and generating a movement interval according to the initial coordinate information, and the movement interval being used for determining whether the test object moves;
wherein, when the test object moves, the signal processing module generates a movement coordinate information, and when the movement coordinate information exceeds the movement interval, the signal processing module determines the test object produces a gesture.

2. The gesture sensing system according to claim 1, wherein the gesture sensing system further includes:
a storage unit, coupled to the signal processing module, for storing a movement trajectory of the gesture and a preset function corresponding to the movement trajectory;
wherein, the signal processing module generates a path of the gesture according to the initial coordinate information and movement change between the movement coordinate information, compares the path of the gesture and the movement trajectory, and executes the preset function corresponding to the movement trajectory.

3. The gesture sensing system according to claim 1, wherein the initial and movement coordinate information includes a first coordinate value generated along a first direction and a second coordinate value generated along a second direction.

4. The gesture sensing system according to claim 3, wherein the first direction and the second direction are perpendicular to each other, and a plane formed by the first direction and the second direction is perpendicular to incident direction of the emitted light.

5. The gesture sensing system according to claim 4, wherein the signal processing module divides the plane according to the positioning coordinate information, the first direction, and the second direction, with the positioning coordinate information as an origin, into four quadrants, and the signal processing module confirms the quadrant where the test object is located according to the positioning coordinate information and the movement coordinate information.

6. The gesture sensing system according to claim 3, wherein the initial and movement coordinate information further includes a third coordinate value generated along a third direction.

7. The gesture sensing system according to claim 6, wherein the first direction, the second direction and the third direction are perpendicular to one another.

8. The gesture sensing system according to claim 1, wherein the test object is the hand of a human body, and the feature point is any part of the human body other than the hand.

9. The gesture sensing system according to claim 1, wherein the signal processing module is one of a server, a computer, and an integrated circuit.

10. A sensing method for the gesture sensing system according to claim 1, comprising the following steps:
a positioning emission step, the light emitter of the gesture sensing system emitting a positioning emission light to the feature point, and the positioning emission light being reflected by the feature point to generate a positioning reflection light;
a positioning sensing step, the light sensor of the gesture sensing system receiving the positioning reflection light and converting into a positioning sensing signal;
a positioning operation step, the signal processing module generating the positioning coordinate information of the feature point according to the positioning sensing signal;
an initial emission step, the light emitter of the gesture sensing system emitting an initial emission light to the test object, and the initial emission light being reflected by the test object to generate an initial reflection light;
an initial sensing step, the light sensor of the gesture sensing system receiving the initial reflection light and converting into an initial sensing signal;
an initial operation step, the signal processing module generating the initial coordinate information of the test object according to the initial sensing signal, and generating a movement interval according to the initial coordinate information;
a movement emission step, the light emitter of the gesture sensing system emitting a movement emission light to the test object, and the movement emission light is reflected by the test object to generate a movement reflection light;
a movement sensing step, the light sensor of the gesture sensing system receiving the movement reflection light and converting into a movement sensing signal;
a movement operation step, the signal processing model generating the movement coordinate information of the test object according to the movement sensing signal; and
a determining step, when the movement coordinate information exceeding the movement interval, the signal processing module determining that the test object generating a gesture.

11. The sensing method according to claim 10, further comprising:
a comparison step, the signal processing module generating the path of the gesture according to the movement change between the initial coordinate information and the movement coordinate information, and the signal processing module comparing the gesture path with a movement trajectory.

12. The sensing method according to claim 11, wherein further comprising:
a storage step, a storage unit storing the movement trajectory of the gesture, and the signal processing module receiving the preset function corresponding to the movement trajectory, and the storage unit storing the preset function.

13. The sensing method according to claim 12, wherein further comprising:
an execution step, when the signal processing module determining the path of the gesture consistent with the movement trajectory, the signal processing module performing he preset function according to the movement trajectory.

14. The sensing method according to claim 10, further comprising:
a dividing step, the signal processing module, based on the positioning coordinate information, the first direction, and the second direction, dividing the space where the test object is located into four quadrants; and a confirmation step, the signal processing module confirming the quadrant where the test object being located according to the positioning coordinate information and the movement coordinate information.
